(19) United States
(12) Patent Application Publication
(10) Pub. No.: US 2012/0255423 A1
(43) Pub. Date: Oct. 11, 2012

(54) HI-HAT SUPPORT STRUCTURE FOR DRUM SET FOR USE WITH A BASS DRUM FOOT PEDAL

(76) Inventor: GEOFF SADDLER, Sammamish, WA (US)

(21) Appl. No.: 13/444,836

(22) Filed: Apr. 11, 2012

Related U.S. Application Data
(60) Provisional application No. 61/473,915, filed on Apr. 11, 2011.

(51) Int. Cl. G10D 13/02

(52) U.S. Cl. 84/422.3

(57) ABSTRACT

Drum kits and drum kit components disclosed herein enable a hi-hat to be disposed over a bass drum foot pedal, such that no cross body motion is required to strike the hi-hat with a right hand drum stick, providing a more ergonomically correct playing experience. In one embodiment, a hi-hat support structure is large enough to accommodate a bass drum pedal being partially inserted into the hi-hat support structure. In another embodiment, a bracket enables a hi-hat support to be mechanically coupled to the bass drum pedal support structure. In yet another embodiment, the bass drum pedal support structure itself provides support for the bass drum pedal and striker, and the hi-hat support column.

### BACKGROUND

A hi-hat (also referred to as a hihat), is a type of cymbal and stand used as a typical part of a drum kit by percussionists in contemporary popular music. The hi-hat includes two opposed cymbals mounted on a stand. The drummer uses the hi-hat to produce sound by either actuating a foot pedal to drive the opposed cymbals together, or by striking the upper cymbal with a drumstick. The hi-hat stand/support structure is a hollow tube, and a narrow metal shaft or rod runs through both cymbals and the hollow tube, and the shaft is mechanically coupled to the hi-hat foot pedal. The upper cymbal is connected to the rod, while the bottom cymbal remains stationary. When the hi-hat foot pedal is actuated, the upper cymbal crashes onto the bottom cymbal (a closed hi-hat). When the hi-hat foot pedal is released, the upper cymbal returns to its original position (an open hi-hat). A tension unit controls the amount of pressure required to drive the upper cymbal into the lower cymbal, and how fast the upper cymbal returns to its open position.

In conventional drum kits, a bass drum is disposed in front of the drummer, and the hi-hat is most often disposed to the left of the bass drum. The positioning of the hi-hat to the left of the bass drum is due to the fact that operation of both the hi-hat and the bass drum require the actuation of foot pedals. Drummers use their right foot to actuate the bass drum pedal, so the hi-hat pedal must be disposed to the left of the bass drum pedal, so the drummer can actuate the bass drum pedal with their right foot and the hi-hat pedal with their left foot. Most drummers use their right drum stick to strike a hi-hat disposed on the left side of the bass drum, which requires the drummer to perform a crossing motion (i.e., the drummer must move their right arm and hand to the left side of their body), which can lead to fatigue or back strain.

At least one drum kit manufacturer has developed a cable system that enables a hi-hat foot pedal disposed to the left of the bass drum to actuate a hi-hat disposed to the right of the bass drum. The drummer then can strike the hi-hat with their right drum stick, avoiding the crossing motion noted above. Unfortunately, such cable systems are prone failure, and require regular replacement. In addition, such cable systems can adversely impact the function of the tension unit, such that when the foot pedal is actuated, the movement of the upper cymbal is not as fluid as desired. It would be desirable to provide further improvements to the hi-hat component in a drum kit.

### SUMMARY

The concepts disclosed herein encompass several embodiments enabling a hi-hat to be mounted to a stand disposed coaxially with a bass drum foot pedal, with the hi-hat foot pedal being spaced apart from a hi-hat stand and mechanically coupled to the hi-hat support structure via a rigid mechanical connector.

In a first embodiment, the hi-hat stand is supported by a base large enough to encompass a bass drum foot pedal, such that the hi-hat is disposed over the bass drum foot pedal. The hi-hat base includes two spaced apart columns, the spacing of the columns being sufficient such that a bass drum pedal can be accommodated between the hi-hat support columns. The hi-hat stand includes a lower support plate to which the spaced apart columns are attached. In at least one related embodiment, the hi-hat stand includes a hollow shaft that extends upwardly from a cross member mechanically coupling the hi-hat support columns together. The cross member is positioned sufficiently high such that movement of the bass drum foot pedal is not interfered with. The hollow shaft includes a rod that is mechanically coupled to a hi-hat foot pedal spaced apart from the hi-hat stand, the rod transferring motion from the foot pedal to the upper cymbal enabling the upper cymbal of the hi-hat to move between the open and closed positions. In an exemplary embodiment, a rigid shaft extends between the hi-hat foot pedal and the hollow shaft. In at least one related embodiment, the lower support plate includes a portion that extends laterally towards a position in which the user is to be seated, the laterally extending portion supporting the bass drum foot pedal. In at least one related embodiment, the lower support plate includes openings for a plurality of fasteners that can be used to secure the base to a substrate. Spring loaded screws represent one exemplary (but not limiting) type of fastener that can be employed.

In a second embodiment, the hi-hat stand is supported by a bracket configured to mechanically couple to at least one support column in a bass drum foot pedal stand. Many bass drum foot pedals are driven by a chain drive, such that the bass drum foot pedal structure includes a pair of spaced apart support columns. The striker for hitting the bass drum is attached to a shaft extending between the pair of spaced apart support columns. In the second embodiment, either the support columns are modified to extend upwardly to a greater extent, to support a hollow hi-hat support shaft, or a bracket couples to at least one of the support columns, and the hollow hi-hat support shaft is supported by the bracket. Again, the hollow shaft includes a rod that is mechanically coupled to a hi-hat foot pedal spaced apart from the bass drum foot pedal/hi-hat support structure, the rod transferring motion from the foot pedal to the upper cymbal enabling the upper cymbal of the hi-hat to move between the open and closed positions. In an exemplary embodiment, a rigid shaft extends between the hi-hat foot pedal and the hollow shaft.

The concepts disclosed herein further encompass a drum kit including a plurality of components. Such a drum kit includes at least a bass drum, a bass drum foot pedal, and at least one of the structure discussed above that enable a hi-hat to be disposed over a bass drum foot pedal.

The concepts disclosed herein further encompass a drum kit including at least a bass drum, a bass drum foot pedal, a hi-hat foot pedal disposed to a left side of the bass drum foot pedal based on a position of a drummer using the drum kit, and a hi-hat disposed over at least one of the bass drum foot pedal and the bass drum.

Various embodiments of the concepts disclosed herein further encompass the following:

A drum kit, including a bass drum, a bass drum foot pedal including a pedal actuated striker for striking the bass drum, a hi-hat foot pedal disposed to a left side of the bass drum foot pedal (based on a position of a drummer using the drum kit), and a hi-hat component disposed over at least one of the bass drum foot pedal and the bass drum. Such a drum kit wherein the hi-hat component is mechanically coupled to the hi-hat foot pedal via a rigid coupling. Such a drum kit wherein the hi-hat component includes a base, the base being large enough such that at least a portion of the bass drum foot pedal is inserted into the hi-hat base. Such a drum kit wherein the hi-hat component includes a hollow shaft supported by the bass drum foot pedal. Such a drum kit wherein the bass drum foot pedal includes a supporting base, the hi-hat component being supported by the supporting base.

A hi-hat support structure, including a base plate, a pair of columns extending upwardly and away from the base plate, the columns being spaced apart by a distance sufficient to enable a bass drum foot pedal to be accommodated in a space between the pair of columns, and a cross member extending between the pair of columns, a distance between the base plate and the cross member being sufficient to allow free motion of a striker of a bass drum foot pedal inserted into the space between the pair of columns.

A combination hi-hat support structure and bass drum foot pedal, including a base plate, a foot pedal, a pair of columns extending upwardly and away from the base plate, a first cross member extending between the pair of columns, the first cross member supporting a striker for striking a bass drum when actuated by the foot pedal, a second cross member extending between the pair of columns, a distance between the base plate and the second cross member being sufficient to allow free motion of the striker, and a hollow hi-hat support shaft extending upwardly and away from the second cross member, the hollow support shaft enabling a hi-hat to be disposed in line with the combination hi-hat support structure and bass drum foot pedal.

A bracket for attaching a hi-hat support structure to a bass drum foot pedal, including a first opening configured to engage a support column attached to a base plate of the bass drum foot pedal, and a second opening configured to engage a proximal end of a hollow support shaft, the hollow shaft enabling a hi-hat to be disposed over the bass drum foot pedal.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 schematically illustrates a prior art drum kit for contemporary music;

FIG. 2 is a block diagram of the prior art drum kit of FIG. 1, from the perspective of a drummer, showing hi-hat cymbals and a hi-hat pedal disposed to a left side of a bass drum;

FIG. 3 is a block diagram of a drum kit modified in view of the concepts disclosed herein, wherein the hi-hat pedal is disposed to the left side of a bass drum, but the hi-hat cymbals have been moved to a location disposed above a bass drum pedal;

FIGS. 4-6 schematically illustrate a first embodiment of a hi-hat support structure enabling a hi-hat to be moved from a left side of the bass drum to a position over a bass drum foot pedal, where the hi-hat support structure includes columns spaced sufficiently far apart to allow the bass drum foot pedal to fit between the hi-hat support structure columns; and

FIGS. 7-9 schematically illustrate a second embodiment of a hi-hat support structure enabling a hi-hat to be moved from a left side of the bass drum to a position over a bass drum foot pedal, where the hi-hat support structure is attached to the bass drum foot pedal.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

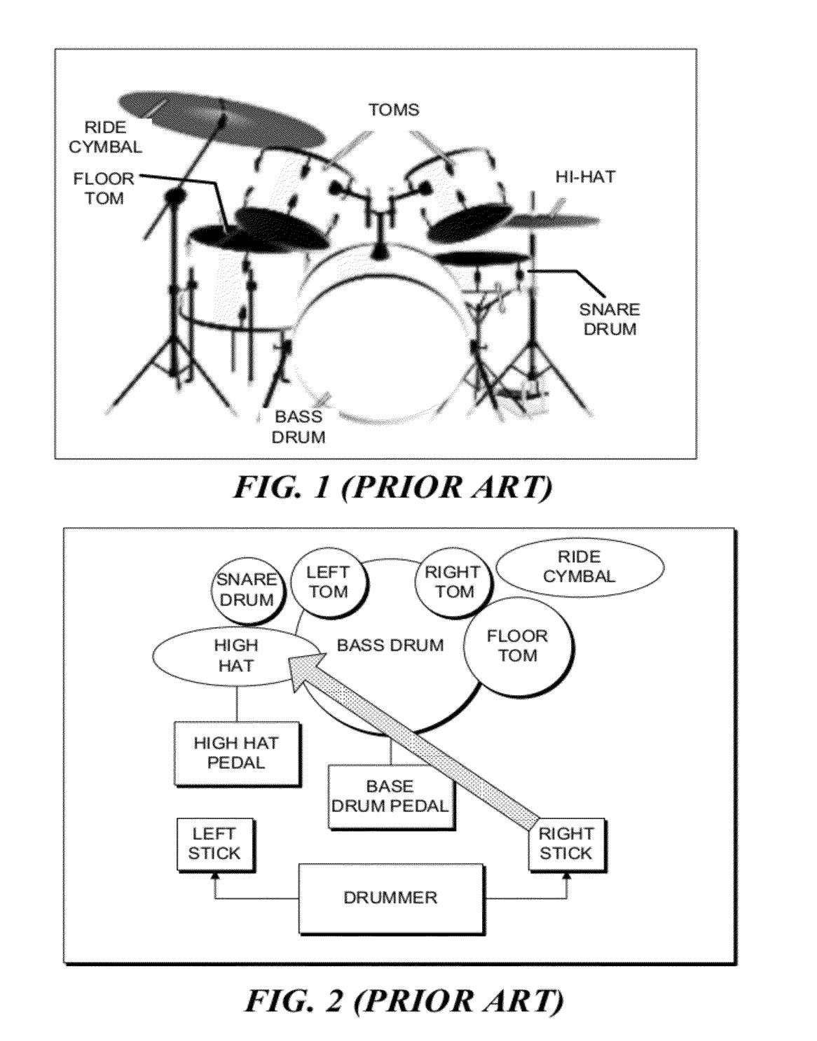

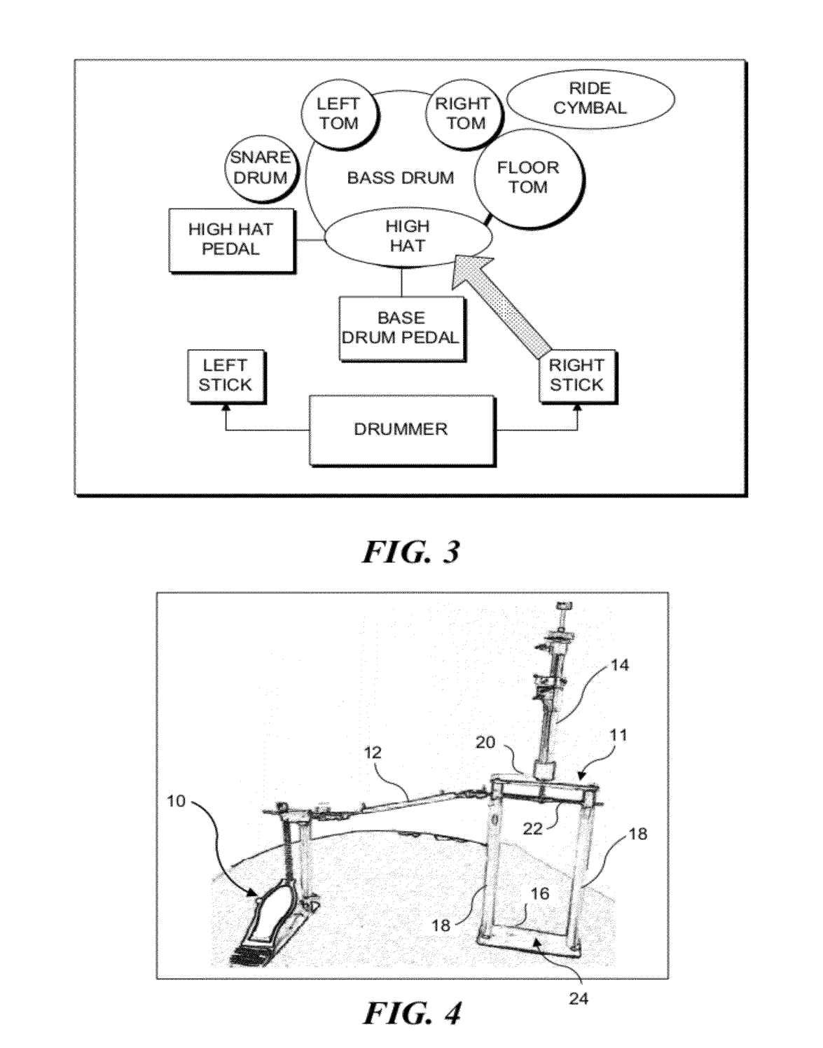

FIG. 1 schematically illustrates a prior art drum kit for contemporary music. Note FIG. 1 is viewed from the perspective of the audience, and not the drummer. It should be noted that the following descriptive text, and the claims that follow, refer to left and right from the perspective of the drummer, not the audience. Thus, FIG. 2 is a block diagram of the prior art drum kit of FIG. 1, from the perspective of the drummer, showing hi-hat cymbals and hi-hat pedal disposed to a left side of a bass drum, along with the snare drum. The floor tom and ride cymbal are disposed to a right side of the bass drum. It should be recognized that individual drummers sometimes vary the relative locations of elements in the drum kit, and some drummers may use additional components, or fewer components. However, the drum kit of FIGS. 1 and 2 should be readily recognizable by any contemporary drummer.

Note that when the drummer uses the right hand drum stick to strike the hi-hat, the right drum stick must cross across the drummer's body, which can lead to fatigue and/or back strain (see the shaded arrow in FIG. 2). Drum Workshops, Inc. (Oxnard, Calif., also known as DW) provides a cable that enables a hi-hat pedal disposed to the left of the bass drum to actuate a hi-hat disposed to the right of the bass drum, where the cable extends behind the drummer, such that the cross body motion is not required. However, such cables have a limited service life, and can undesirably reduce the speed at which the upper hi-hat cymbal moves between the open and closed positions.

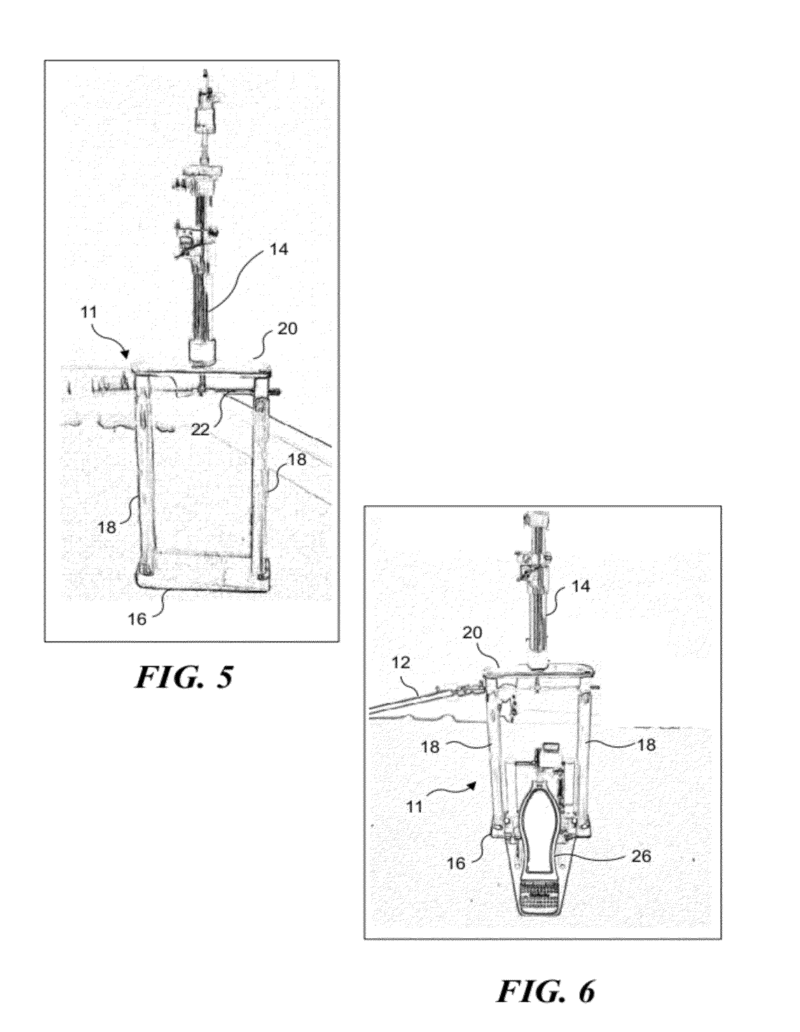

FIG. 3 is a block diagram of a drum kit modified in view of the concepts disclosed herein, wherein the hi-hat pedal is disposed to the left side of a bass drum, but the hi-hat cymbals have been moved to a location disposed above a bass drum pedal. The relative positions of the hi-hat support structure and the hi-hat pedal are such that a rigid mechanical connector, rather than a cable, can be used to enable the hi-hat to be actuated by the hi-hat foot pedal, and preventing the undesirable cross body motion to strike the hi-hat with the right hand drum stick (see the shaded arrow in FIG. 3).

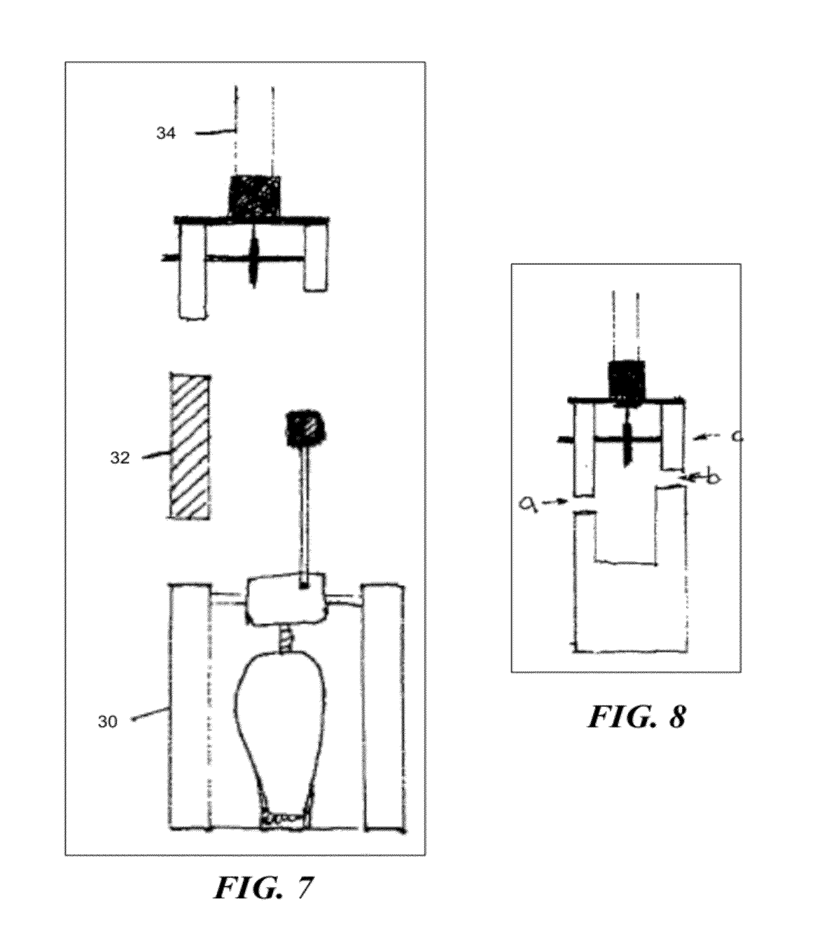

FIGS. 4-6 schematically illustrate a first embodiment of a hi-hat support structure enabling a hi-hat to be moved from a left side of the bass drum to a position over a bass drum foot pedal, where the hi-hat support structure includes columns spaced sufficiently far apart to allow the bass drum foot pedal to fit between the hi-hat support structure columns.

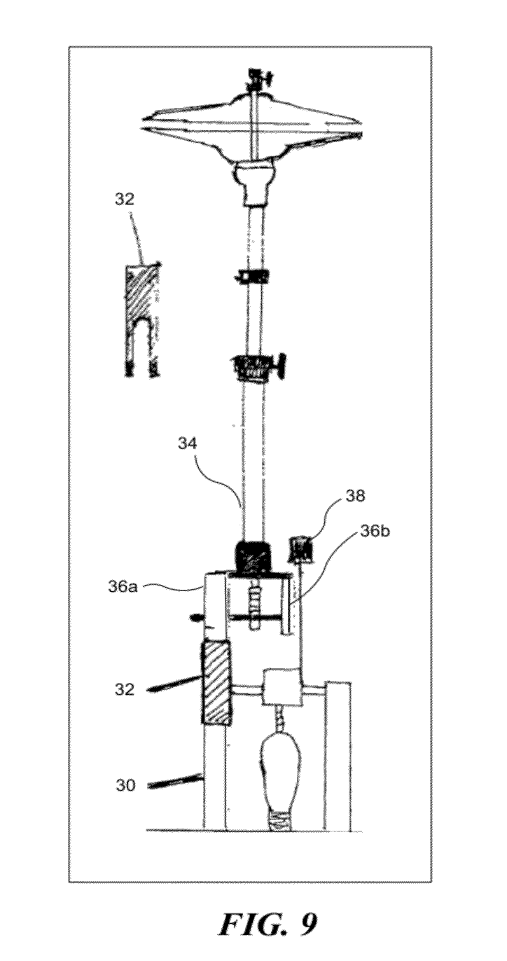

Referring to FIG. 4, a hi-hat foot pedal structure 10 is disposed on a left side (from the perspective of the drummer) of a hi-hat support structure 11. The hi-hat support structure includes a support base 16, a pair of spaced apart columns 18, an actuator rod 22, a cross member 20, and a hollow support shaft 14. The function of hi-hat foot pedal structure 10, actuator rod 22, and hollow support shaft 14 are consistent with conventional drum kit components, and will not be described in detail. Note the relative positions of hi-hat foot pedal structure 10 and hi-hat support structure 11 are such that a rigid mechanical connector 12 can be used to transfer the motion from hi-hat foot pedal structure 10 to actuator rod 22. Such rigid connectors are available from drum kit manufacturers such as DW. Note that rigid mechanical connector 12 can be inclined at an angle (i.e., the portion of the connector coupled to the hi-hat foot pedal can be at a lower height relative to the portion of the connector coupled to the hi-hat actuator rod) without losing functionality. Significantly, spacing between columns 18 is sufficient such that a conventional bass drum foot pedal can be accommodated in a space 24. Further, spacing between cross member 20 (and actuator rod 22) and support base 16 is sufficient to allow free motion of the rod and striker elements (such elements are understood by the artisan of skill, and are shown in FIG. 7) in the bass drum foot pedal.

FIG. 5 provides another view of hi-hat support structure 11.

FIG. 6 provides a view of hi-hat support structure 11 with a bass drum foot pedal 26 being disposed between columns 18. In at least one related embodiment, support base 16 is sized and shaped to fully support each portion of bass drum foot pedal 26 (noting that as illustrated in FIGS. 4-7, support base 16 will only support a front portion of bass drum foot pedal 26). In some embodiments, support base 16 will include one or more openings that enable the support base to be secured to a substrate supporting the drum kit, to prevent the support bass from moving when the bass drum foot pedal is actuated.

It should be understood that rather than implementing hi-hat support structure 11 and bass drum foot pedal 26 as separate components, one could integrate them into a single unified component, to provide a bass drum foot pedal component that also provides support for a hi-hat, such that the hi-hat is disposed over the bass drum foot pedal.

Various portions of the disclosure presented herein refers to the position of a hi-hat as being disposed over the bass drum foot pedal. In at least one embodiment, the opposed pair of cymbals in the hi-hat are positioned such that they are substantially centered over the bass drum foot pedal (substantially as used in this context referring to plus or minus 10%). In at least one other embodiment, the opposed pair of cymbals in the hi-hat are positioned such that at least some portion of the hi-hat cymbals are disposed over the bass drum foot pedal. In at least one other embodiment, the opposed pair of cymbals in the hi-hat are positioned such that some portion of the hi-hat cymbals are disposed over the bass drum itself. Each of these different hi-hat positions enable the hi-hat foot pedal (when disposed to the left of the bass drum foot pedal) to be mechanically coupled to the hi-hat via a rigid coupling, as well an enabling the drummer to strike the hi-hat with the right hand drumstick without the cross over motion described above in connection with FIG. 2. Each of these different positions are also achievable by positioning the hi-hat support structure in the same location as the bass drum foot pedal (either by providing a hi-hat support structure that can accommodate a bass drum foot pedal, or by attaching the hi-hat support structure to a bass drum foot pedal).

FIGS. 7-9 schematically illustrate a second embodiment of a hi-hat support structure enabling a hi-hat to be moved from a left side of the bass drum to a position over a bass drum foot pedal, where the hi-hat support structure is attached to the bass drum foot pedal.

Referring to FIG. 7, a bass drum foot pedal 30 includes a pair of vertical support columns, and a striker assembly. A bracket 32 is used to attach a modified hi-hat support structure 34 to one of the vertical support columns in the bass drum foot pedal. FIG. 8 illustrates how a conventional hi-hat support structure is modified by cutting the structure at points a & b, to enable the modified structure to be attached to bass drum foot pedal 30 via bracket 32. FIG. 9 illustrates bass drum foot pedal 30, bracket 32 and modified hi-hat structure 34 in an assembled configuration. Note that some hi-hat support structures may need to be modified at point c (see FIG. 8) to allow the striker arm of the base drum foot pedal to move freely. Referring to FIG. 9, support column 36a of hi-hat support structure is relatively thicker than support column 36b, because some of the material of support column 36b has been removed to allow striker arm 38 to move freely. It should be recognized that the amount of material that must be removed is a function of the hi-hat support structure that is modified as shown in FIG. 8. Some existing hi-hat support structures may not require removal of material at point c.

Referring to FIG. 9, note that an enlarged side view of bracket 32 is included. In an exemplary embodiment, bracket 32 includes a slotted portion that enables the bracket to slide over a cross bar in the bass drum foot pedal that is used to support the striker arm.

It should be recognized that a combined hi-hat support structure and bass drum foot pedal, such as that shown in FIG. 9, can be implemented in a variety of ways. A drum kit manufacturer could design a hi-hat support structure and a bass drum foot pedal that could be used independently, or combined using one or more brackets (such as bracket 32). Further, the drum kit manufacturer could implement the bass drum foot pedal such that one or more of the vertical support columns used in the bass drum foot pedal also provides support for a hi-hat (i.e., an integrated bass drum foot pedal and hi-hat support structure).

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A drum kit, comprising:
(a) a bass drum;
(b) a bass drum foot pedal including a pedal actuated striker for striking the bass drum;
(c) a hi-hat foot pedal disposed to a left side of the bass drum foot pedal, based on a position of a drummer using the drum kit; and
(d) a hi-hat component disposed over at least one of the bass drum foot pedal and the bass drum.

2. The drum kit of claim 1, wherein the hi-hat component is mechanically coupled to the hi-hat foot pedal via a rigid coupling.

3. The drum kit of claim 1, wherein the hi-hat component comprises a base, the base being large enough such that at least a portion of the bass drum foot pedal is inserted into the hi-hat base.

4. The drum kit of claim 1, wherein the hi-hat component includes a hollow shaft supported by the bass drum foot pedal.

5. The drum kit of claim 1, wherein the bass drum foot pedal includes a supporting base, the hi-hat component being supported by the supporting base.

6. A hi-hat support structure, comprising:
(a) a base plate;
(b) a pair of columns extending upwardly and away from the base plate, the columns being spaced apart by a distance sufficient to enable a bass drum foot pedal to be accommodated in a space between the pair of columns; and
(c) a cross member extending between the pair of columns, a distance between the base plate and the cross member being sufficient to allow free motion of a striker of a bass drum foot pedal inserted into the space between the pair of columns.

7. The hi-hat support structure of claim 6, wherein the base plate includes a first portion extending between the pair of columns, and a second portion that extends away from the pair of columns, in a direction orthogonal to the first portion.

8. A combination hi-hat support structure and bass drum foot pedal, comprising:
(a) a base plate;
(b) a foot pedal;
(c) a pair of columns extending upwardly and away from the base plate;
(d) a first cross member extending between the pair of columns, the first cross member supporting a striker for striking a bass drum when actuated by the foot pedal;
(e) a second cross member extending between the pair of columns, a distance between the base plate and the second cross member being sufficient to allow free motion of the striker; and
(f) a hollow hi-hat support shaft extending upwardly and away from the second cross member, the hollow support shaft enabling a hi-hat to be disposed in line with the combination hi-hat support structure and bass drum foot pedal.

9. A bracket for attaching a hi-hat support structure to a bass drum foot pedal, comprising:
(a) a first opening configured to engage a support column attached to a base plate of the bass drum foot pedal, and a
(b) a second opening configured to engage a proximal end of a hollow support shaft, the hollow shaft enabling a hi-hat to be disposed over the bass drum foot pedal.
